(19) United States
(12) Patent Application Publication
(10) Pub. No.: US 2023/0153752 A1
(43) Pub. Date: May 18, 2023

(54) FOOD TRANSPARENCY SYSTEM

(71) Applicant: FARMTRACER, LLC, Royal City, WA (US)

(72) Inventors: Austin Wells Allred, Royal City, WA (US); Micheal Green, Cedar City, UT (US)

(21) Appl. No.: 17/988,991

(22) Filed: Nov. 17, 2022

Related U.S. Application Data
(60) Provisional application No. 63/264,293, filed on Nov. 18, 2021.

(51) Int. Cl. G06Q 10/087; G06K 19/06

(52) U.S. Cl. CPC G06Q 10/087; G06K 19/06037; G06K 19/06028

(57) ABSTRACT

A computer implemented method and system for providing food transparency comprises receiving data associated with a food item, associating a unique identifier with the food item, providing the unique identifier associated with the food item at a point of sale of the food item, and displaying configured data associated the food item, accessible according to the unique identifier provided with the food item. The unique identifier can comprise a QR code or a bar code. The methods and systems further comprise generating a web page populated with the configured data associated the food item wherein the unique identifier comprises a link to the web page.

### CROSS REFERENCE TO RELATED PATENT APPLICATIONS

This application claims the priority and benefit under 35 U.S.C. § 119(e) of U.S. Provisional Patent Application Serial No. 63/264,293 filed November 18, 2021, entitled “FOOD TRANSPARENCY SYSTEM.” U.S. Provisional Patent Application Ser. No. 63/264,293 is herein incorporated by reference in its entirety.

### TECHNICAL FIELD

Embodiments are generally related to the field of farming. Embodiments are also related to the field of sustainable farming. Embodiments are further related to the field of computer devices and mobile devices used for food tracking and accountability. Embodiments further relate to sustainable food sourcing. Embodiments are also related to methods, systems, and devices for providing food transparency to consumers.

### BACKGROUND

Modern supply chains have changed the manner in which most people get their food. Local farmer's markets and produce stands have largely been replaced by bigger commercial food producers more capable of providing food on the scale necessary to feed the population.

While advances in food production efficiency have made it economically feasible to feed nearly every person in the United States, there is a growing desire among consumers to understand the source of their food. At a farmer's market that was a relatively simple task since a customer could simply ask the farmer where the food was grown. With larger scale food production, identifying the food source is much more complex, particularly for produce, meat, and dairy products, where standard package or shelf labeling often does not include food source information.

Current labeling also fails to give consumers a clear picture of the quality of the food products they are purchasing. For example, simple gradings for beef quality offer only a snapshot of the quality of the associated meat products, without providing any further insight into whether the meat is healthy, the food handling practices associated with the meat, and/or the environmental impact of the food production. Similar deficiencies exist across the spectrum of food products. Consumers have a relatively small amount of information about the food they are purchasing, and ultimately consuming.

Likewise, a growing segment of consumers are interested in understanding the environmental impact of the food they eat. Many consumers are willing to pay higher prices for locally sourced, or sustainably grown food, which may have a smaller environmental impact. While there are numerous eco-friendly farms nationwide, it is difficult for a regular consumer to determine whether the produce, meat, fish, dairy, etc. they purchase at their local supermarket was produced in an environmentally responsible way.

Accordingly, there is a need in the art for methods and systems that allow consumers to track food sources, food quality and safe handling practices, as well as the environmental impact of the food they purchase, as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide improved methods and systems for farm to table food tracing.

It is another aspect of the disclosed embodiments to provide a method, system, and apparatus for food source tracking.

It is another aspect of the disclosed embodiments to provide methods, systems, and apparatuses for tracking food handling practices.

It is another aspect of the disclosed embodiments to provide methods, systems, and apparatuses for associating environmental impacts with consumer ready food products.

In the embodiments herein, a system, method, and apparatus for food and farm transparency is disclosed. The embodiments have two basic purposes. The first, is to provide consumers information relating to the content, quality, safety, and environmental impact of the foods they purchase. In certain embodiments, the methods and systems can be used by consumers to check food data before purchasing the food. The other basic purpose is to provide farms, dairy farmers, and other food producers an opportunity to share what they make and the means by which they are able to deliver food to consumers.

In an embodiment, a computer implemented method comprises receiving data associated with a food item, associating a unique identifier with the food item, providing the unique identifier associated with the food item at a point of sale of the food item, and displaying configured data associated the food item, accessible according to the unique identifier provided with the food item. In an embodiment, the unique identifier comprises at least one of a QR code and a bar code. In an embodiment, the method comprises generating a web page populated with the configured data associated the food item wherein the unique identifier comprises a link to the web page. In an embodiment, the data associated with the food item comprises animal data, the animal data further comprising at least one of: animal type, animal age at slaughter, animal genealogy, gross carbon emissions of animal, net carbon emissions of animal, animal diet, and/or animal location. In an embodiment, the data associated with the food item comprises orchard data, the orchard data further comprising at least one of: plant type, plant variety, plant age, pollination time, gross carbon emissions of plant, net carbon emissions of plant, and/or plant location. In an embodiment, the data associated with the food item comprises crop data, the crop data further comprising at least one of: crop type, crop variety, crop row, crop age at harvest, water volume applied to crop, gross carbon emissions of crop, net carbon emissions of crop, and location of crop. In an embodiment, the data associated with the food item comprises nut data, the nut data further comprising at least one of: nut type, nut variety, nut tree age at harvest, water volume applied to nut tree, gross carbon emissions of nut tree, net carbon emissions of nut tree, and location of nut tree. In an embodiment, receiving data associated with a food item further comprises importing the data associated with the food item. In an embodiment, the method further comprises calculating a net carbon change associated with the food item according to carbon data associated with the food item wherein the net carbon change associated with the food item comprises the total carbon emissions associated with production of the food item less the total carbon sequestration associated with the product of the food item. In an embodiment, the food item comprises a discreet food item for consumer purchase.

In another embodiment, a system for food transparency comprises a computer system, the computer system comprising: at least one processor; and a computer-usable medium embodying computer program code, the computer-usable medium capable of communicating with the at least one processor, the computer program code comprising instructions executable by the at least one processor and configured for: receiving data associated with a food item, generating a unique identifier for the food item, rendering the unique identifier associated with the food item for association with the food item at a point of sale for the food item, and serving configured data associated the food item, accessible using the unique identifier associated with the food item. In an embodiment, the unique identifier comprises at least one of a QR code and a bar code. In an embodiment, the computer program code comprising instructions executable by the at least one processor is further configured for populating a web page with the configured data associated the food item, wherein the unique identifier comprises a link to the web page. In an embodiment, the system further comprises a data collection computer system, the data collection computer system comprising: at least one processor; and a computer-usable medium embodying computer program code, the computer-usable medium capable of communicating with the at least one processor, the computer program code comprising instructions executable by the at least one processor and configured for: collecting data associated with the food item, and exporting the data associated with the food item. In an embodiment the system comprises at least one of: a water monitoring system configured to monitor water usage associated with the food item; a soil monitoring system configured to monitor soil composition associated with the food item; a methane monitoring system configured to monitor methane output associated with the food item; and a beehive monitoring system configured to monitor bees associated with the food item. In an embodiment, the computer program code comprising instructions executable by the at least one processor is further configured for generating the configured data associated the food item wherein the food item comprises a discreet food item for consumer purchase. In an embodiment, the computer program code comprising instructions executable by the at least one processor is further configured for providing feedback data associated with a food producer associated with the food item. In an embodiment, the computer program code comprising instructions executable by the at least one processor is further configured for calculating a net carbon change associated with the food item according to carbon data associated with the food item. In an embodiment, the net carbon change associated with the food item comprises the total carbon emissions associated with production of the food item less the total carbon sequestration associated with the product of the food item.

In an embodiment, a system for food transparency comprising: a tracking computer system, the tracking computer system comprising: at least one processor; and a computer-usable medium embodying computer program code, the computer-usable medium capable of communicating with the at least one processor, the computer program code comprising instructions executable by the at least one processor and configured for: receiving data associated with a food item, generating a unique identifier for the food item, rendering the unique identifier associated with the food item for association with the food item at a point of sale for the food item, serving configured data associated the food item, accessible using the unique identifier associated with the food item, and populating a web page with the configured data associated the food item, wherein the unique identifier comprises a link to the web page; and a data collection computer system, the data collection computer system comprising: at least one processor; and a computer-usable medium embodying computer program code, the computer-usable medium capable of communicating with the at least one processor, the computer program code comprising instructions executable by the at least one processor and configured for: collecting data associated with the food item and exporting the data associated with the food item.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4 depicts a block diagram of a system for food tracking and transparency, in accordance with the disclosed embodiments;

FIG. 5 depicts a block diagram of a transparency module, in accordance with the disclosed embodiments;

FIG. 6 depicts a block diagram of a consumer portal, in accordance with disclosed embodiments;

FIGS. 7A illustrates a block diagram of an animal tracking system, in accordance with the disclosed embodiments;

FIG. 7B illustrates a block diagram of a plant tracking system, in accordance with the disclosed embodiments;

FIG. 8A illustrates a block diagram of a carbon tracking system, in accordance with the disclosed embodiments;

FIG. 8B illustrates a block diagram of a bee tracking system, in accordance with the disclosed embodiments;

FIG. 9A illustrates an exemplary first screen of a consumer portal, in accordance with the disclosed embodiments;

FIG. 9B illustrates an exemplary interface of a consumer portal, in accordance with the disclosed embodiments;

FIG. 9C illustrates an exemplary food unit interface of a consumer portal, in accordance with the disclosed embodiments;

FIG. 9D illustrates an exemplary food unit interface of a consumer portal, in accordance with the disclosed embodiments;

FIG. 9E illustrates an exemplary diet interface of a consumer portal, in accordance with the disclosed embodiments;

FIG. 9F illustrates an exemplary carbon emissions interface of a consumer portal, in accordance with the disclosed embodiments;

FIG. 9G illustrates an exemplary additional carbon interface of a consumer portal, in accordance with the disclosed embodiments;

FIG. 9H illustrates an exemplary additional feed interface of a consumer portal, in accordance with the disclosed embodiments;

FIG. 9I illustrates an exemplary additional food interface of a consumer portal, in accordance with the disclosed embodiments;

FIG. 9J illustrates another exemplary food unit interface of a consumer portal, in accordance with the disclosed embodiments;

FIG. 10 depicts a producer portal, in accordance with the disclosed embodiments;

FIG. 11 depicts a method of providing food transparency, in accordance with the disclosed embodiments;

FIG. 12 depicts a method of tracking food data with the systems disclosed herein, in accordance with the disclosed embodiments;

FIG. 13 depicts another method of tracking food data with the systems disclosed herein, in accordance with the disclosed embodiments;

FIG. 14 depicts another method of tracking food data with the systems disclosed herein, in accordance with the disclosed embodiments; and

FIG. 15 depicts another method of tracking food data with the systems disclosed herein, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

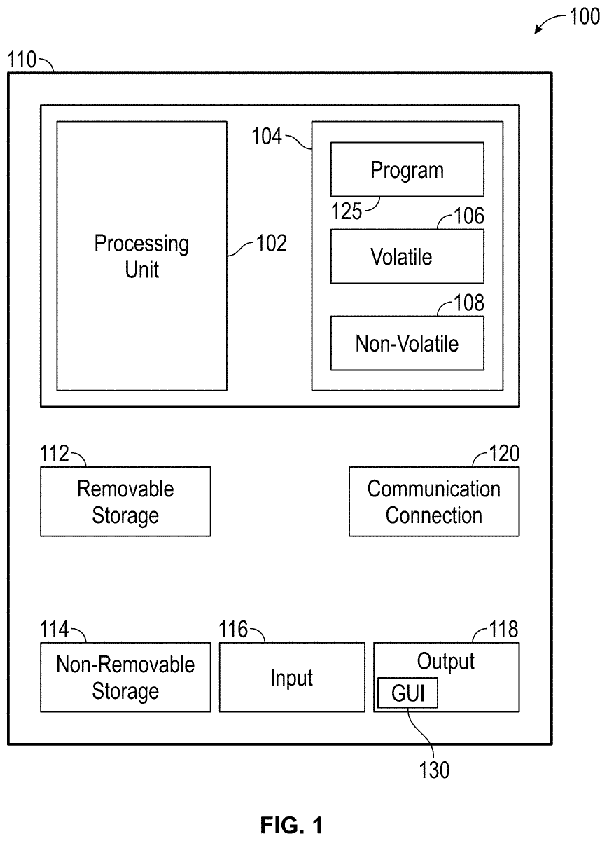

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

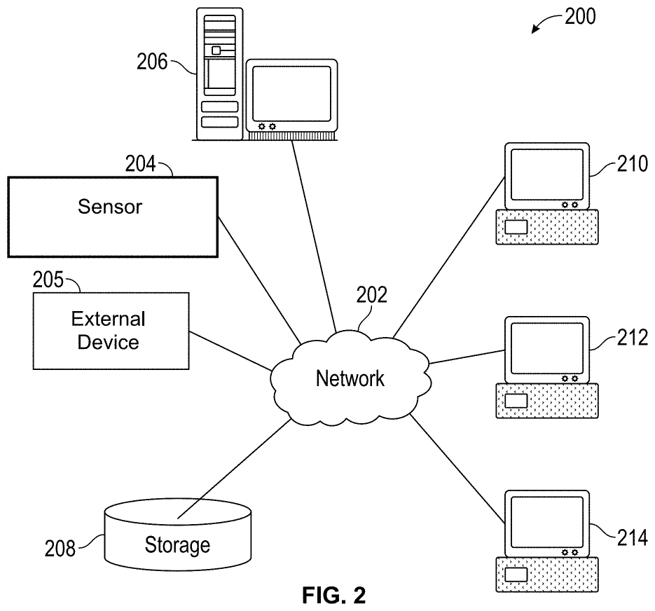

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, and the like in which embodiments of the present invention may be implemented. Note that the system 200 can be implemented in the context of a software module such as program module 125. The system 200 includes a network 202 in communication with one or more clients 210, 212, and 214, and external device 205. Network 202 may also be in communication with one or more RFID and/or GPS enabled devices, monitors, or sensors 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as RFID and/or GPS enabled device 204, and a memory storage unit such as, for example, memory or database 208. It should be understood that RFID and/or GPS enabled device 204 may be embodied as a mobile device, cell phone, tablet device, monitoring device, detector device, sensor microcontroller, controller, receiver, transceiver, or other such device.

In the depicted example, RFID and/or GPS enabled device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and RFID and/or GPS enabled device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

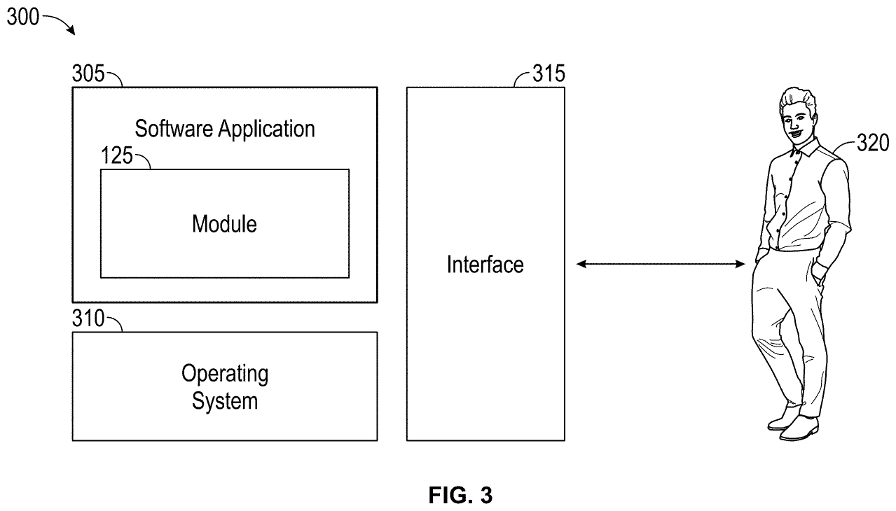

FIG. 3 illustrates a software system 300, which may be employed for directing the operation of the data-processing systems such as computer system 100 depicted in FIG. 1.

Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino, and the like. Therefore, the descriptions of the exemplary embodiments, which follow, are for purposes of illustration and not considered a limitation.

The disclosed embodiments provide consumers full transparency as to what they are purchasing and eating. The system provides a unique ID, such as a QR code associated with each food unit or food item (the terms “food unit” and “food item” are used interchangeably). A consumer side user can scan the QR code to reveal information about the food product, including information such as the locations where the food was grown and/or shipped, what has gone into the food (e.g., the soil for plant based foods, or the feed for animal based foods), the carbon emitted or sequestered in the lifetime of the food production, and the care that has gone into the harvesting and packaging of the consumer ready food unit.

The system provides the unique ability to connect an end user with food production and quality information. The system serves as a bridge between a farmer and consumer together forming a symbiotic information exchange relationship. The disclosed system provides relevant information for each animal and/or item of produce including, but not limited to carbon footprint of the farm and animal, geographic data, lifecycle information, handling and cared used in harvesting the food unit, and the type of feed/fertilizer used with the product.

The system can principally be a cloud-based architecture to allow information input to occur in real-time in the field. That information can be configured into an easy to read and understand reports unique to each food unit, which are made accessible to the consumer through a unique code (e.g., a QR code or bar code) which can be generated when the food unit (e.g., animal or produce batch) is processed and ready for the consumer.

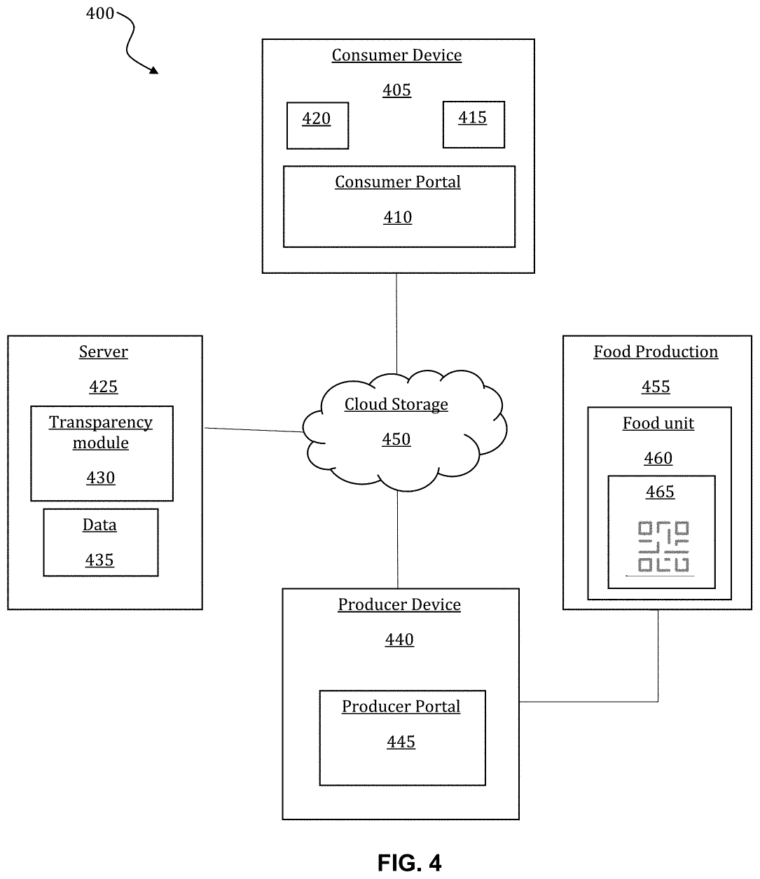

In the embodiments disclosed herein, a system, method, and apparatus for food transparency is disclosed. FIG. 4 illustrates a block diagram of a system 400 for food transparency. The system 400 can generally include a mobile device, or consumer device 405 that provides a consumer portal 410. The consumer portal 410 can serve as the interface through which the consumer interacts with the system 400. It should be appreciated that, in certain embodiments, the consumer portal 410 can comprise a website accessible by a consumer device, such as a cell phone, tablet device, computer, or the like. In other embodiments, the consumer portal 410 can be embodied as a software application or app, downloaded to the consumer device.

The system 400 is configured to store, organize, and display records associated with a discrete food item 460. As used herein the food item 460 or discrete food item can comprise a consumer ready unit of food, most commonly packaged for display and sale. The system 400 can generate a URL which can be used to create and make changes to the records relating to individual food items. The system is further configured to provide consumers information relating to the individual foods, specifically food data associated with the discrete food item 460, via the URL.

As illustrated in FIG. 4, the consumer device 405 can be any device connected to the internet. Preferably the device can be equipped with a camera 415, and has a GPS receiver 420, such that the device 405 can verify position and time, and can collect images of the unique identifier. In certain embodiments, the consumer device 405 can comprise a mobile device, or smart phone, a tablet device, a computer, a smart watch, vehicle display screen, or other such device.

The consumer device 405 can be equipped with a consumer portal 410. In certain cases, the consumer portal 410 can comprise a standalone software module (e.g., an app). In other embodiments, the consumer portal 410 can be a web portal. The consumer portal 410 serves as the interface through which the consumer interacts with the food transparency system 400. The interface can comprise a specially designed graphical user interface that allows the user to capture the unique identifier for a discrete food item 460, send that identifier to the server 425, and receive information relating to the food item 460 associated with the identifier. This can be achieved in a number of ways as further detailed herein.

The mobile device 405 can interact with other aspects of the system through a wired or wireless connection via the world wide web. In certain embodiments, this can be achieved using a cloud computing architecture as illustrated in FIGS. 1-3. In certain embodiments, a server 425 can provide data 435 storage and can provide a transparency module 430.

The system 400 further includes a producer device 440. The producer device 440 can comprise a mobile device, or smart phone, a tablet device, a computer, a smart watch, other such device, or a combination of such devices. The producer device 440 can be equipped with a producer portal 445. The producer portal 445 serves as the interface through which a producer, such as a farmer, dairy farmer, rancher, or other such food producer interacts with the transparency system 400. An interface associated with the producer portal 445 can be used to collect and/or upload various data about foodstuffs. It should be understood that the producer device 440 can comprise multiple devices accessible by multiple producers, and/or sensors, or other such devices as further detailed herein.

The transparency module 430 can comprise the root application (or software) that is used to control the system. The server 425 can serve data to, and accept data from, the consumer device 405 and producer device 440. In other embodiments, cloud storage 450 can be used to store some or all of the relevant data and/or software associated with the system 400.

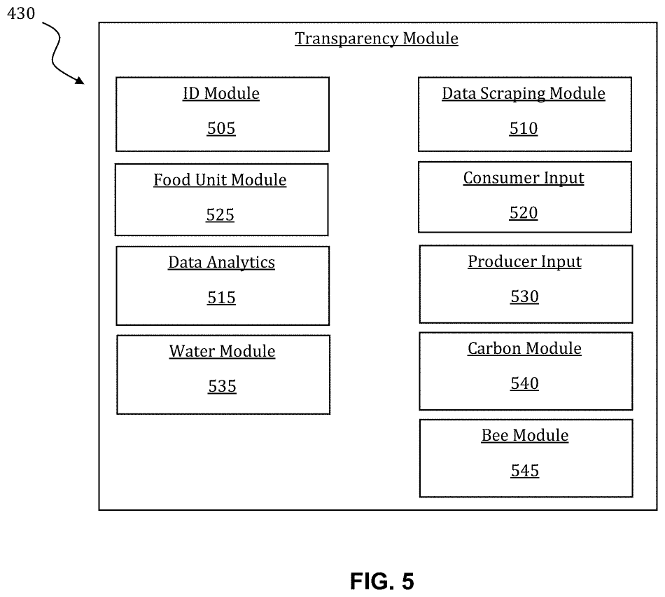

FIG. 5 illustrates a system diagram of the transparency module 430. The transparency module 430 can include a food unit module 525 at the heart of the system. The food unit module 525 can be used to input new food units 460 produced by the producer. For example, in certain embodiments, the food unit module 525 can include data fields in a structured database indicative of food units 460 comprising:
An animal—including age, genealogy, carbon emitted, what it has eaten, location, type, etc.
An orchard block—including bees pollinated time, when planted, carbon footprint, water applied, variety, location, etc.
A Ground Crop unit -including row, variety, when planted, water applied, carbon footprint, when harvested, location, etc.
Nut production—including location of trees, types of nuts, when planted, carbon footprint, water applied, etc.
A Product (berries, honey, etc.)—including bees pollinated time, when planted, carbon footprint, water applied, variety, location, etc.

It should be appreciated that the above list is exemplary, and the food unit module can be configured to accept other data associated with a given food unit 460, as well as data associated with other types of food units 460 in other embodiments.

For example, in certain embodiments, animal data further comprises at least one of animal type, animal age at slaughter, animal genealogy, gross carbon emissions of animal, net carbon emissions of animal, animal diet, and animal location. In an embodiment, the data associated with the food item 460 comprises orchard data, the orchard data further comprising at least one of: plant type, plant variety, plant age, pollination time, gross carbon emissions of plant, net carbon emissions of plant, and plant location. In an embodiment, the data associated with the food item 460 comprises crop data, the crop data further comprising at least one of: crop type, crop variety, crop row, crop age at harvest, water volume applied to crop; gross carbon emissions of crop, net carbon emissions of crop, and location of crop. In an embodiment, the data associated with the food item 460 comprises nut data, the nut data further comprising at least one of: nut type, nut variety, nut tree age at harvest, water volume applied to nut tree, gross carbon emissions of nut tree, net carbon emissions of nut tree, and location of nut tree.

Collecting data for a food unit 460 can be accomplished with a dedicated device such as producer device 440, or can be collected and entered by a producer, using a device such as producer device 440.

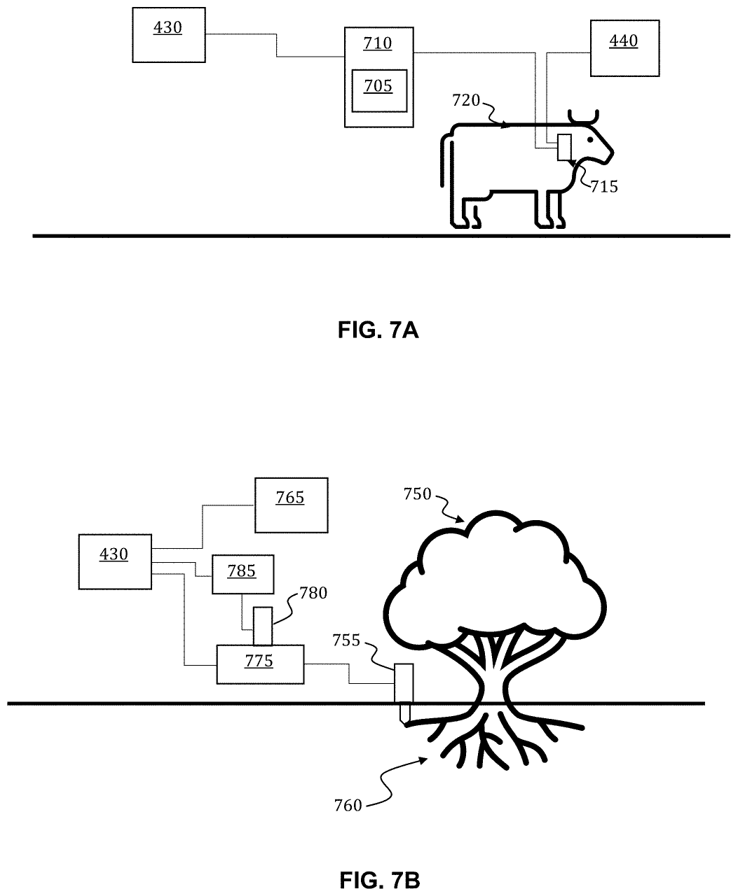

FIG. 7A and 7B illustrate exemplary data collection systems. For example, animal data points can be tracked by an ear chip 715 that is tracking all the food eaten (as collected by a scale system) that weighs every ingredient and weighs the feed delivered. That data can be divided by the weight of animal 720 to determine the total for each animal 720 per day.

In exemplary embodiments, the food unit module can interact with an API 705 of a separate system 710 used to collect data about farm animals 720 or plant 750 data. Many farmers use such an external system 710 to track metrics associated with their food production. Such metrics can include various data fields associated with the software. The food unit module 525 can scrape data via the API 705 and format it for presentation via the disclosed consumer portal. Some or all collected data as disclosed herein can be collected in this way, in certain embodiments.

ID module 505 can be used to assign a unique identifier to each food unit 460 in the food unit module 525. In certain embodiments, the ID module 505 can generate and assign a unique identifier to each new food unit 460 as it is collected by the food unit module 525. In other embodiments, other identifiers such as web links, numbers, codes, symbols, or the like can be used. The food unit 460 or food item can comprise a discreet food item for consumer purchase. For example, a food unit 460 or food item could comprise a discreet package of steak, a discreet package of ground beef, a discreet package of produce, a discreet package of nuts, a discreet container of honey, etc.

In certain embodiments, a water module 535 can be used to collect water data related to a specific food unit 460. For example, in certain embodiments, watering systems that make use of a center pivot circle with row crops can be tracked. As the pivot turns, a sensor 755 can measure how much water is used and at what rate-with a GPS. The associated data can be provided to the water module 535, which can populate the associated data in the food unit module 525.

As illustrated in FIG. 7B, producers may elect to use a water monitor 755 and/or water monitoring service to update water information in the water module 535. Additionally, certain soil moisture data can be collected via additional methods. Such methods can use electrical conductivity sensors that measure the volumetric water content of the soil surrounding a water sensor. This volumetric water content value can be normalized to account for differences in soil type from site to site in order to provide the producer with a measurement of available water in relation to soil water holding capacity at field capacity and permanent wilting point.

In certain embodiments, two to four sensors can be installed within the soil root zone 760 at differing depths depending on the rooting depth of the monitored crop 750 and the desired intensity of measurement. A sensor 765, such as a rain gauge or pressure sensor, can provide input to the water module 535, and can be combined with the sensor data to record how much water was applied and/or how long the system operated to achieve the observed results.

In certain embodiments, the sensors 765 can be connected to a datalogger 770 connected to, and usually in proximity to, the sensors 755 (via wired or wireless communication networks) and fitted with stereo plug connections. Data from each sensor 755 is logged in the datalogger 770 and a datapoint is recorded as specified; typically, anywhere from one to four times per hour.

For less management intensive crops, the dataloggers 770 that collect the data from the sensors at the installation site are fitted with a radio modem 780. The producer can visit each location on a predetermined interval (typically twice per week) to interface with the radio modem 780 with a radio receiver 785 at the field edge to collect new data. Alternatively, the radio modem780 can send data to a receiver electronically at selected intervals. This data is uploaded to the transparency module 430 where it can be plotted in order to produce graphic reports available to the user via the consumer portal 410. In other embodiments, reports can be generated by a third party service provider. Reports can be electronically delivered to the producer or synchronized with the food unit module 525.

For high management intensive crops, the dataloggers 775 are instead fitted with a cellular modem 780 and “push” technology so that data can be uploaded to a cloud server on regular intervals each day without the need for a field visit by the producer (or 3^{rd} party service provider). This type of “push” technology allows the datalogger 775 to keep its cellular hardware powered off for most of the time allowing long battery life. The datalogger 775 uses a unique cryptographic signature and checksum to protect the integrity of the data as it is transferred over the cellular network and internet as it's uploaded to the transparency module 430. The datalogger 775 keeps track of the data successfully uploaded to the data service. If the datalogger 775 is unable transfer data during one regularly scheduled session, the data is included in the next upload session. Using web and app-based options, measurement data is available for download on demand, and can be used to update the food unit module 525 as necessary.

In certain embodiments, the water data is graphed and presented on a chart with time along the x-axis and “Percent of Plant Available Water” along the y-axis, with traces for each sensor 755 representing each depth monitored in the soil/root zone 760 with the data analytics module. With this data, the data analytics module 515 can determine “how wet” a given soil is, observe trends, and make more qualified decisions on irrigation timing to determine when to water and how much to apply at any given irrigation event.

The water module 535 can further monitor greenwater. Greenwater includes water taken out of a basin or lagoon, green, or sea water. Such water is often delivered by the truck load. In such circumstances the delivery of green water for the day is recorded in a data structure and loaded into the water module 535.

Water data can then be apportioned to a given food unit 460 and reported to the consumer via the consumer portal 410.

In certain embodiments, a carbon module 540 can be used to collect data associated with carbon capture and release, in association with the disclosed embodiments. In certain embodiments, a database such as the SSURGO database which has been collecting data on the soils (the clay, sand, silt, peat, chalk, rock, and loam...) can be used.

In certain embodiments, a data scraping module 510 can be used to extract data from a third party carbon accounting system. An example is the CometFarm database. Farm specific information can be provided to the third party carbon accounting system database to ensure the correct data is collected.

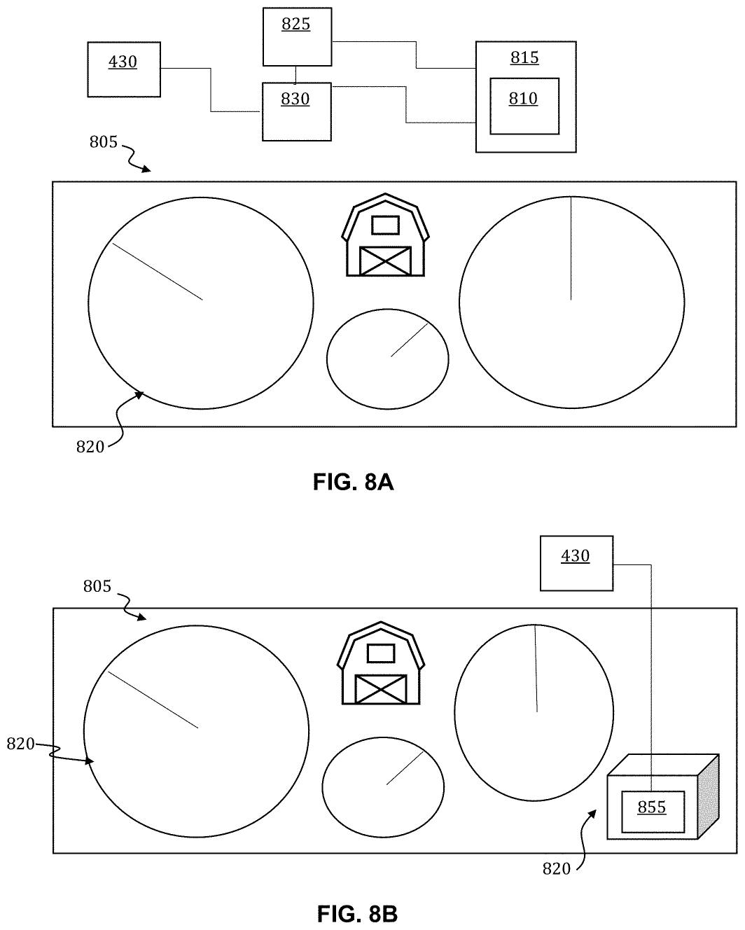

As illustrated in FIG. 8A, the collected data can include satellite imagery 810 of a farm 805, collected with a satellite 815. Satellite imagery 810 can be used to find and outline, for example, the location of a field 820. The data for a given location such as a field 820 can include what has been planted, harvested, water applied, fertilizer applied, any piece of equipment that went through the field, greenwater or compost applied, limed, and burned. This can include historical information, for example, for the last ten years (or other such time scale), along with current practices.

The third party carbon accounting system 825 can use a formula that yields the carbon footprint for that unit/field and carbon change. This number can be scraped using the data scraping module 510 and provided to the carbon module 540, and then input to the food unit module 525 to be associated with the relevant food unit 460.

For example, on an exemplary farm 805, the carbon emitted verse the carbon sequestered can be calculated for each food unit 460. To find that quantity, a whole farm and ranch carbon greenhouse gas accounting system 830, or third party carbon accounting system 825 can be used. Some of the data relevant to determine the carbon footprint for the farm includes water and fertilizer put on the fields, cow slurry spread, all tractor work, harvest dates, and yields. Other data may also include housing life, number of cattle, how much manure is used, and how it is handled. This data can then be provided to an external source such as a third party carbon accounting system 825, where they use a combination of SSURGO database information for the soil surveys and yearly pre-reviewed “Quantifying Greenhouse Gas Fluxes in Agriculture and Forestry,” to give the specific farm its own carbon sequestered tonnage. Furthermore, proprietary soil modeling can be used for further data collection. This can include the official greenhouse gas accounting tool from the USDA and NRCS, or other such external tool. In the exemplary case, the results will include the total carbon emitted in production of a certain food unit 460 and the total carbon sequestered in its production. The difference indicates the total carbon footprint of the food unit 460.

In certain embodiments, a bee module 545 can be used to collect data associated with pollination. Bees play a significant role in agriculture. They pollinate crops, increase yields, and give rise to a lucrative honey industry. Many fruits, nuts, and vegetables require pollination by bees and other insects in order to yield fruit, and without pollinators these crops could all but disappear from grocery store shelves. The agricultural benefit of honeybees is estimated to be between 10 and 20 times the total value of honey and beeswax. Bees pollinate 80% of the world's plants including 90 different food crops.

The bee module 545 is used to collect data associated with Bees as illustrated in FIG. 8B. This data can include, for example, when bees are put in a corner of a growing unit that they there are going to pollinate (usually March or April), the data is recorded by the beekeeper/owner with an identifier such as a bar code 855 on each of the hives 850. Location of the bees can further be tracked. The beekeeper can scan the barcode 855 when the hives 850 are delivered and when he takes them. These dates are recorded as data and then put on the data structure associated with the system via the bee module 545.

Various other input data can also be provided via the producer input module 530. This allows the producer to select and report relevant data, which can be stored in the food unit module 525. The producer input can be provided via the producer device 440.

Likewise, the system can be configured to accept consumer input via the consumer input module 520. Consumer input can include other information they would like to see, feedback on the experience, a chat back function so that the consumer can communicate with the farmer, other places where the products can be purchased, etc.

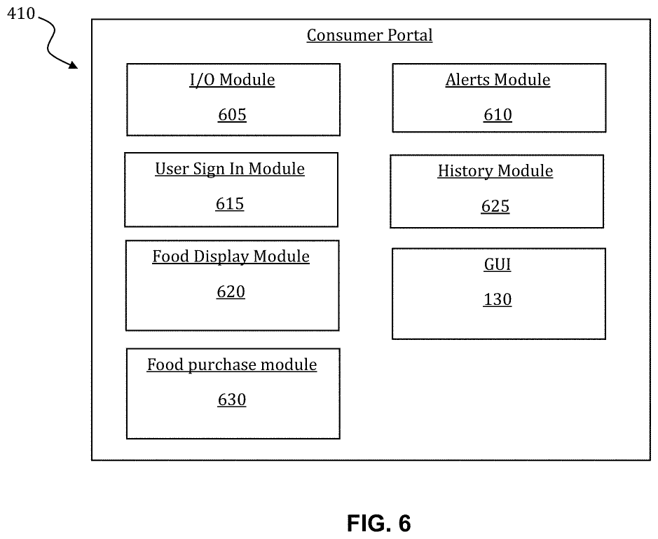

FIG. 6 illustrates an exemplary embodiment of a consumer portal 410 in accordance with the disclosed embodiments. The consumer portal 410 serves as the interface through with the consumer interacts with the system 400. The consumer portal 410 can be embodied as specially designed software that is executed by a mobile device or other computer system such as computer system 100. The consumer portal can also be embodied as a webpage, served on the consumer device. The consumer portal 410 can include a user interface embodied as a graphical user interface, such as GUI 130. The consumer portal 410 allows the user to interact with the transparency module 430. The interface 130 can display food unit 460 information from the food unit module 525 and or the transparency module 430. The user interface can present the information available with respect to the food they are purchasing.

The consumer portal 410 can include a user sign-in module 615. The user sign-in module 615 can be used to verify that the user is a registered user.

The consumer portal 410 can operate in conjunction with the transparency module 430 to collect information relating to the consumer scans and purchases. For example, the consumer portal 410 can include a directory or memory structure dedicated to each consumer. The consumer's scan history of food items 460 can be saved in the memory structure, along with items purchased by the consumer. The transparency module 430 can then calculate total carbon sequestered by the consumer, or other such metrics.

The transparency module 430 can further correlate the consumer purchases with specific producers. The transparency module 430 can identify producers the consumer commonly purchases food products from. The consumer portal 410 can then be loaded with audio or video content from such producers including but not limited to live videos of livestock, or video of a field during harvest. Other such media content regarding a specific producer can be made available to the consumer via the consumer portal 410.

The system 400 can further alert the consumer to food items 460 from producers the consumer identifies as a “favorite producer,” or when previously purchased food items are available at a retail outlet near the consumer. The system 400 can provide location data for such food items, prices, quantities, remote purchase options, delivery options and the like, to allow the consumer to conveniently purchase the food item 460. Such data is provided to the consumer with a food purchase module 630 in the consumer portal 410.

The consumer portal 410 can also include an I/O module 605. The I/O module 605 can be configured to allow the user to capture a unique identifier 465 associated with a food item 460. In certain embodiments, this can be a QR code which the user can capture using an imaging device such as a camera, integrated in the consumer device 405. In other embodiments, the I/O module can include a field that allows the user to enter the unique identifier manually through a keypad, or via voice control.

For example, in certain embodiments, the QR code can be embodied as a connection to a “food of the week”. In such an embodiment, the QR code doesn't change, but the food processed that week is uploaded, and the average can be viewable by following the URL connected to the QR code.

The consumer portal 410 can further include a food display module 620, which can present food data with respect to food items 460 associated with a unique identifier, this can include location data, food treatment data, food quality, carbon footprint data, water usage data, pollination data, maps illustrating food travel from source to sales point, and other such data as detailed herein. The data can be organized in charts, graphs, or with other such visual indicators to make it easy for the consumer to assess the various characteristics of the food.

The consumer portal 410 can further include a history module 625. The history module can store and/or display data associated with any previous food item 460 selected or purchased by the user.

Finally, the consumer portal 410 can include an alerts module 610. The alerts module 610 can comprise a system to provide an alert if a food item 460 associated with the unique identifier 465 has some associated defect, problem, or other characteristic of note. For example, the alerts module 610 can provide an alert via text message, SMS notification, or other such alert, if a selected food item 460 is passed its safe date for consumption (i.e., the food has expired, or is no longer fresh). The alerts module 610 can further provide an alert if a food item 460 is poorly sourced, requires a net positive carbon footprint beyond a preset threshold, was overly consumptive of water, etc.

The consumer portal 410 can further include information associated with the farmer or other such food producer. This can include social information such as stores relating to the farmer, videos, social content, etc.

The consumer portal 410, thus serves as the mechanism through which food related data is presented to the consumer. The consumer portal 410 can further include an I/O module 605 that allows the user to enter information.

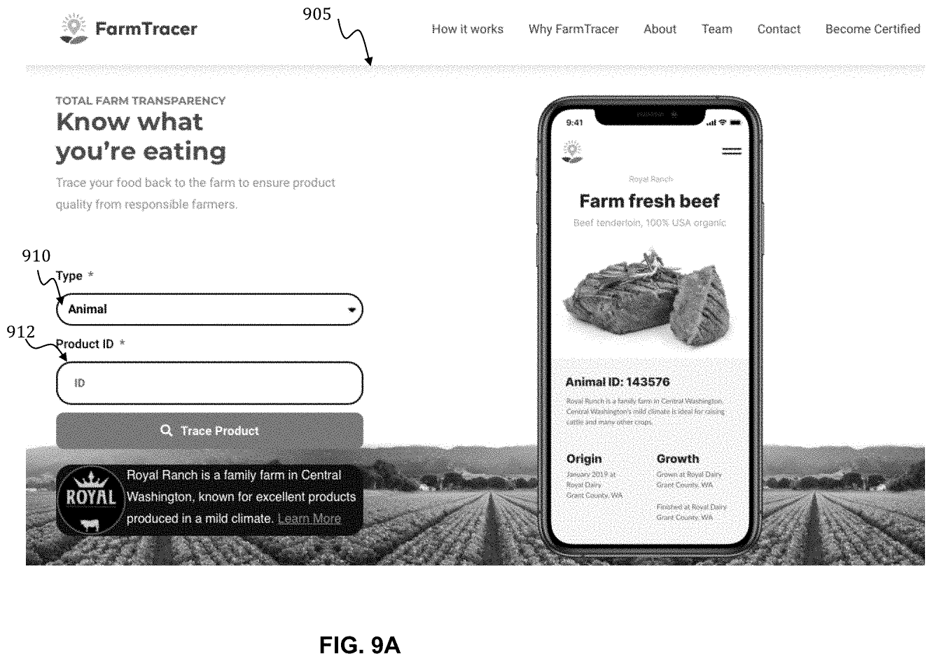

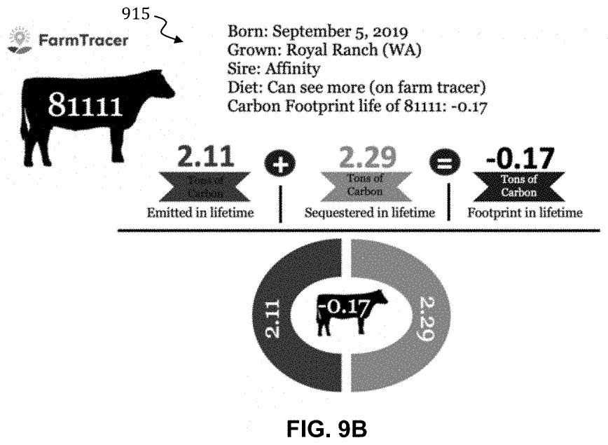

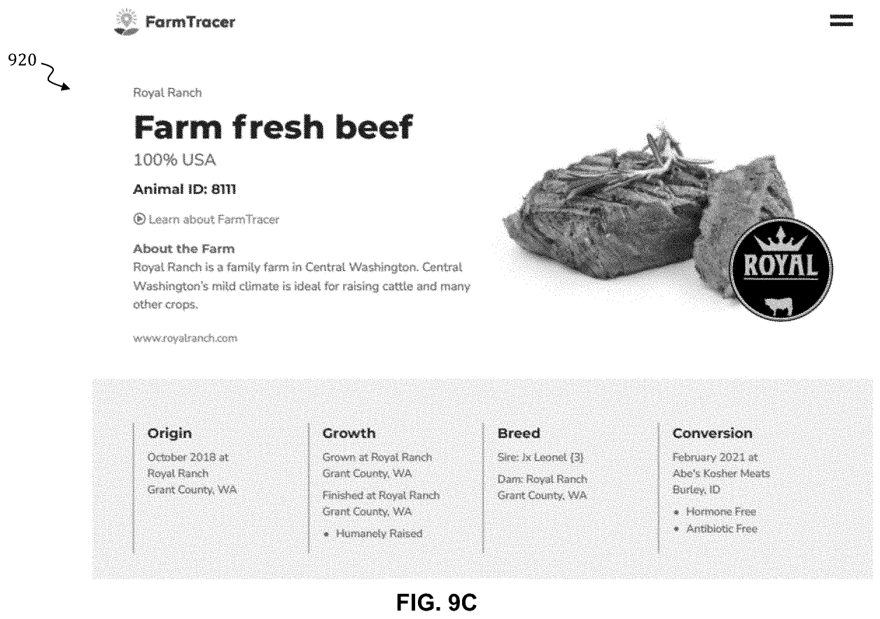

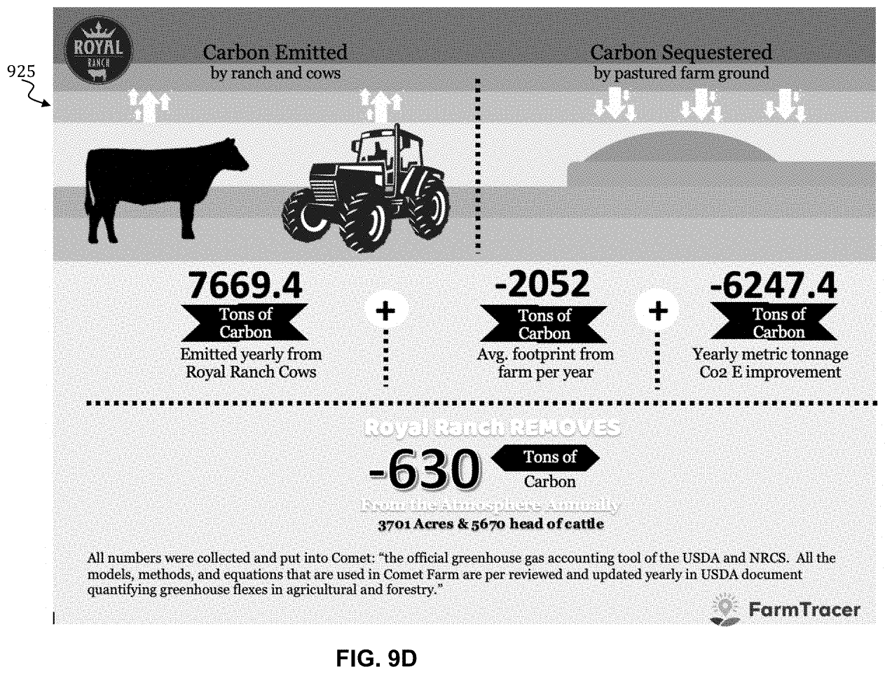

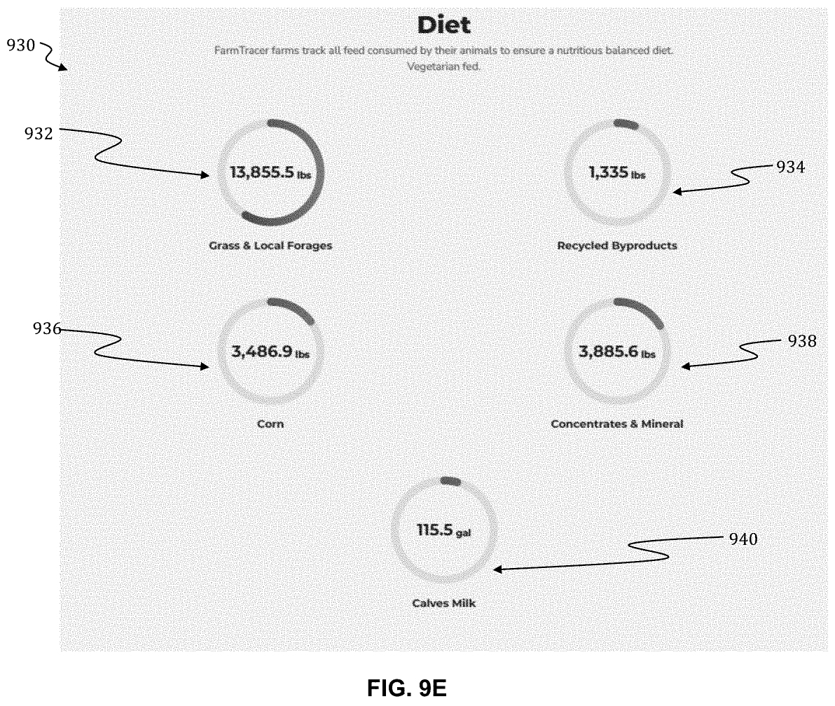

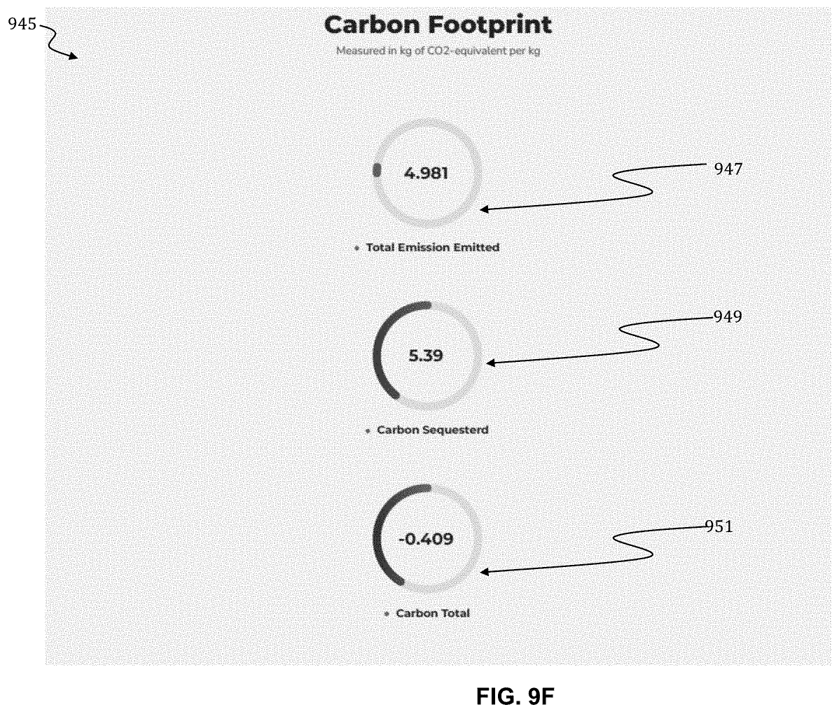

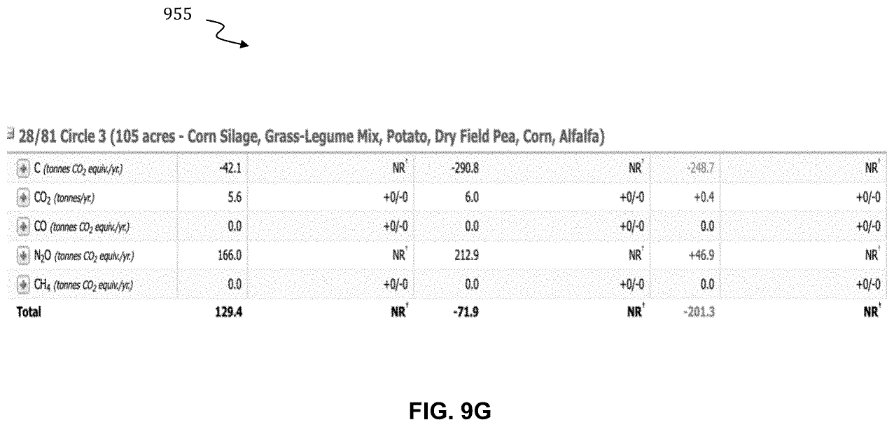

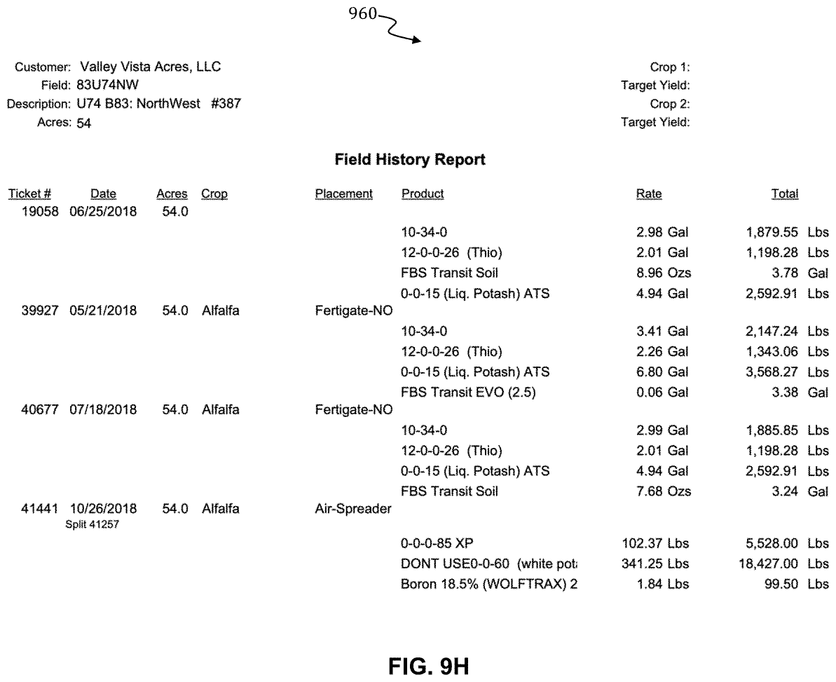

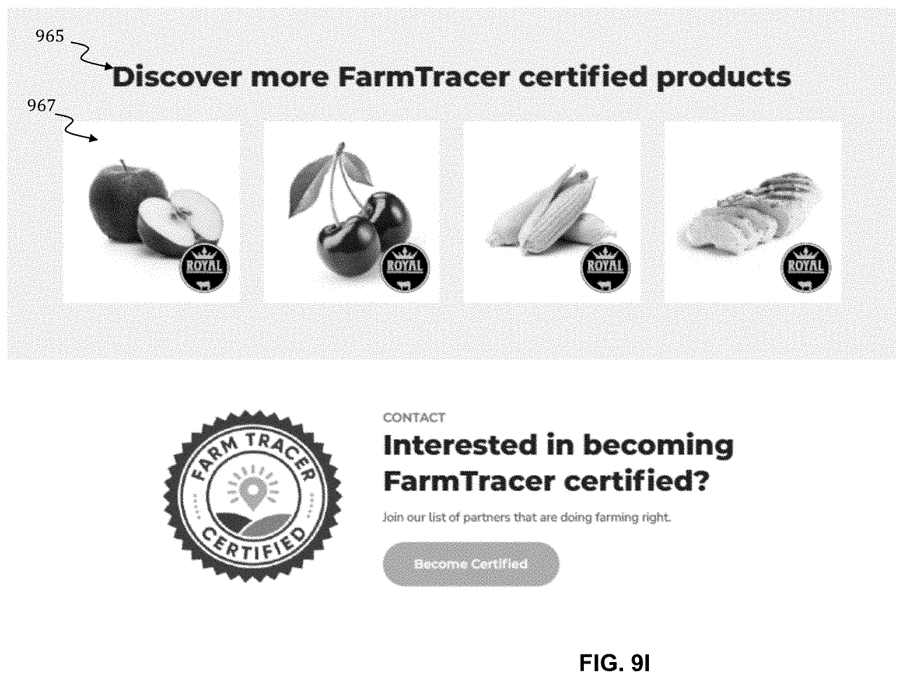

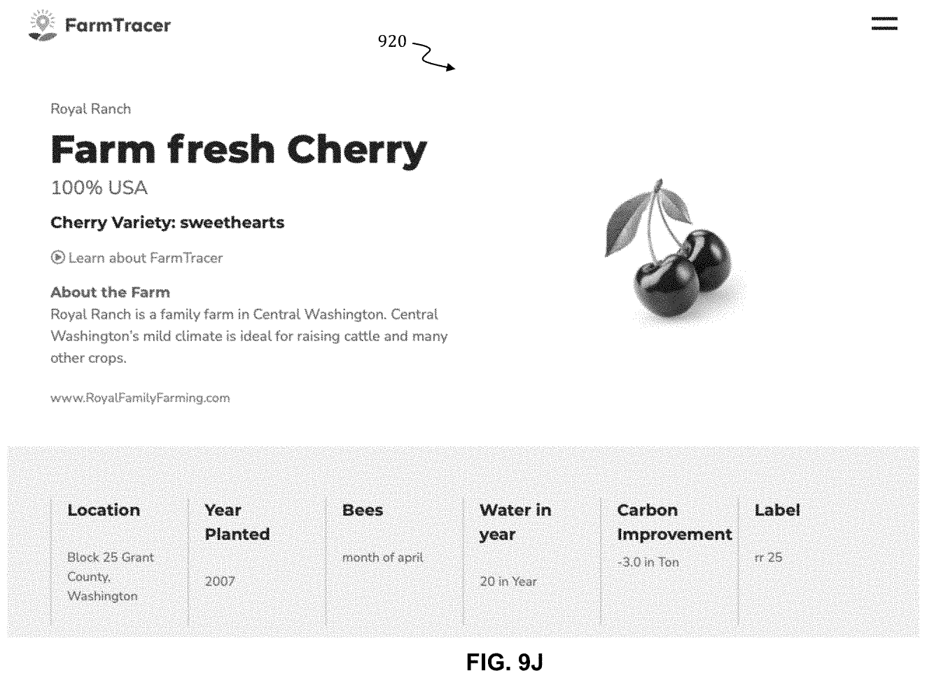

FIGS. 9A-9J illustrate interfaces associated with a system 400, data and/or information which can be presented using the system 400, e.g., through the consumer portal 410. For example, FIG. 9A illustrates a first screen 905 of a consumer portal 410 in accordance with the disclosed embodiments.

As illustrated, the first screen 905 can include a drop down menu 910 to select a type of food unit 460, and a field 912 or entering the identification code associated with the food unit 460. It should be appreciated that, in other embodiments, the user need only scan an ID code which automatically can identify the food type and associated product ID.

Once the food type and product ID are entered, data associated with food unit 460 can be provided as illustrated in FIGS. 9B-9J. FIG. 9B illustrates an exemplary interface 915 providing data associated with a food unit 460 (in this case beef). In interface 915 the source of the beef is identified (in this case as “ROYAL RANCH”), as well as the date the cow was born, the diet and the associated carbon emissions, presented as a graph.

FIG. 9C illustrates food unit interface 920. The food unit interface provides information about the animal used to produce the food item 460, including date of birth, treatment conditions during growth, breed, and conversion to a food unit 460.

FIG. 9D illustrates farm carbon interface 925 providing total carbon output of the specific farm associated with the food unit 460. This can include carbon emissions, and carbon reductions measured against one another, along with a total carbon output for the specific ranch associated with the food item 460.

In FIG. 9E diet interface 930 is illustrated. This interface 930 shows feed data associated with the identified beef including pounds of grass and forage 9332, recycled byproducts 934, corn 936, concentrates/minerals 938, and calves' milk 940. In other embodiments other data may also be provided. FIG. 9F similarly illustrates carbon emissions interface 945 showing carbon data associated with the products of this food unit 460, including total emissions 947, carbon sequestered 949, and total carbon impact 951. FIG. 9G illustrates additional carbon details interface 955 illustrating additional and supporting data. FIG. 9H show additional feed interface 960 providing additional information provided via the consumer portal.

FIG. 9I illustrates additional food interface 965, providing links 967 to additional certified products. This allows a user to select additional certified goods. The products and associated links provided in the additional food interface 965 can be generated based on past user food selections.

FIG. 9J illustrates another food unit interface 920, with similar information presented via a consumer portal for another food unit 460 (in this exemplary case “fresh cherries”). As illustrated, the consumer portal shows the location of the cherries, the year the tree was planted, bees associated with pollination, the amount of water consumed, the carbon emission associated with the cherry food unit, and a label. It should be noted that other data can also be included in other embodiments.

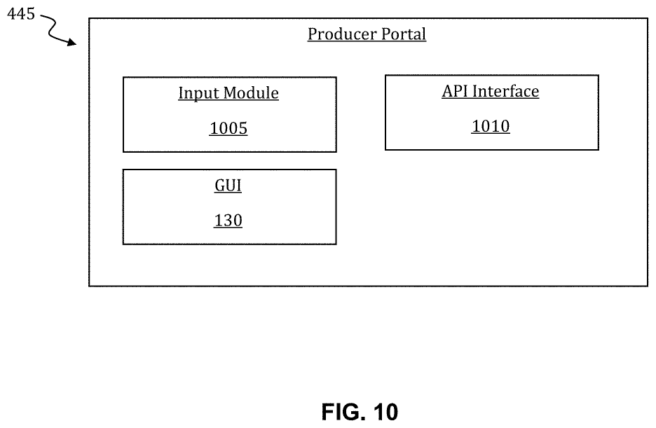

FIG. 10 illustrates an exemplary embodiment of a producer portal 445 in accordance with the disclosed embodiments. The producer portal 445 serves as the interface through which the producer interacts with the system 400. The producer portal 445 can be embodied as specially designed software that is executed by a mobile device or other computer system, such as computer system 100. The producer portal 445 can include a user interface 1015 embodied as a graphical user interface, such as GUI 130. The producer portal 445 allows the producer to interact with the transparency module 430. The interface 130 can display food unit 460 information from the food unit module 525 and or the transparency module 430. The user interface can include an input module 1005 for the producer to enter information into the system and/or to see feedback regarding food the producer has produced.

In other embodiments, the producer portal 445 can comprise software configured to interface with one or more application program interfaces (APIs) of one or more external systems via API interface 1010. In certain embodiments, data trackers, computers, carbon calculators, etc. which a farmer may already be using for data logging, can include an API, which the producer portal can use to collect associated data. The producer portal can further parse and format such data so that its contents can be formatted and presented on the consumer portal 410.

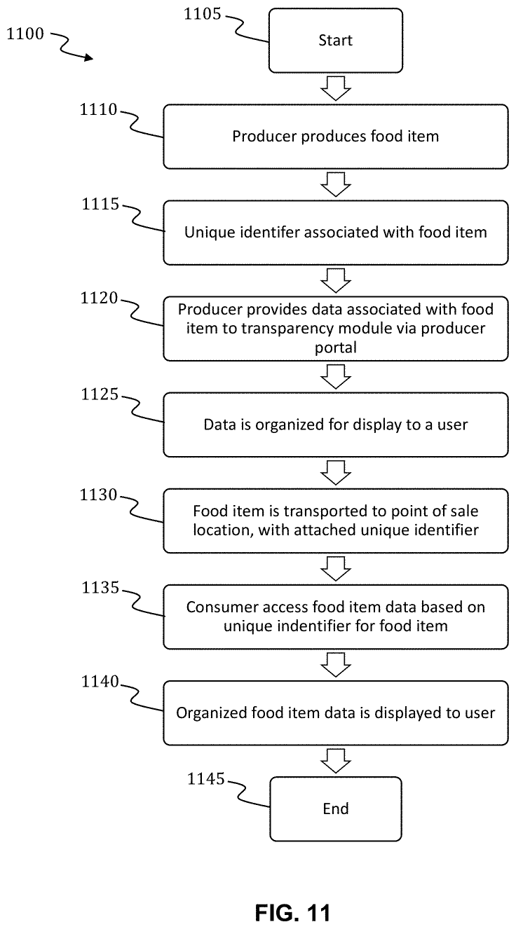

FIG. 11 illustrates steps associated with a method 1100 for reporting food production in accordance with the disclosed embodiments. The method begins at step 1105. First, at step 1110 a food producer can produce a food item 460. This can include produce, meat, dairy, fish, nuts, honey, or other such food products. Next the food item 460 can be labeled with a unique identifier at step 1115. The unique identifier can comprise a QR code or other such unique identifier.

Once the food item 460 has a unique identifier, at step 1120 the producer can upload any data associated with the production of the food item 460. This can include various data inputs as disclosed herein. It should be noted that data collection, and data entry can commence and/or proceed at any stage in the method. Once the information is provided, the transparency module can be used to organize the data into consumer viewable format at step 1125. For example, the information can be categorized, represented in charts or graphs, and otherwise made simple to understand.

The food item 460 can then be shipped to a point of sale location at step 1130. Point of sale location data can be provided to the system so that the consumer facing information can include maps illustrating the path from the producer to the point of sale location, along with other purchase data.

The consumer is then able to enter the unique identifier into a consumer portal at step 1135. Food information associated with that food item 460 can be served to the consumer for the selected item at step 1140, based on the information provided by the producer.

Consumer scan or purchase history can be made available to producers via the producer portal. This allows the producer to evaluate the popularity of various food items 460 they produce and adjust their efforts in food production accordingly. Furthermore, the producer portal can allow the producer to sell produce directly to consumers interested in purchasing (or re-purchasing) food items 460. The method ends at 1145.

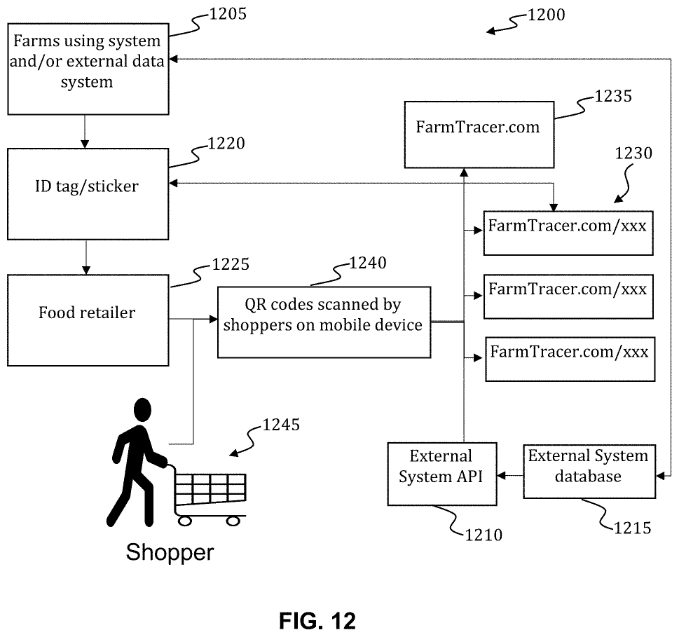

FIG. 12 illustrates a block diagram and associated operational flow illustrating the operation of a system 1200 for food transparency tracking in accordance with the disclosed embodiments. As illustrated, farms raise livestock, fish, or produce. Most farmers already use a system for tracking data metrics associated with the food they produce. In certain embodiments, farmers can use data collection provided by the system to collect such data as illustrated at 1205. In other embodiments, the system 1200 can interface with the API 1210 of the data tracking systems 1210 and associated databases 1215, the farmer already uses, to scrape data associated with the production of the associated food units 460. Food units 460 can be assigned an ID number.

The food is then processed and packaged into consumables. The system can generate an identifier such as a QR code 1220 that is associated with a URL and the animal or plant unit. The QR code 1220 (or other such identifier) can be included on the food unit packaging for retail sale at a food retailer 1225. As illustrated in FIG. 12, a unique URL 1230 for each food unit 460 can be created and associated with the system's home website 125 or transparency module 430.

The retail food products can be sold to retail outlets 1225, such as grocery stores, meat sellers, or other such retailers, where the food units 460 are made available for consumer purchase. Shoppers 1245 can select the given food item 460 and have the option of scanning the QR code at 1240 on the food item 460 or entering the identifier using the consumer portal. The consumer portal can link the shopper to the unique URL 1230 with information (as detailed herein) relating to the food unit 460.

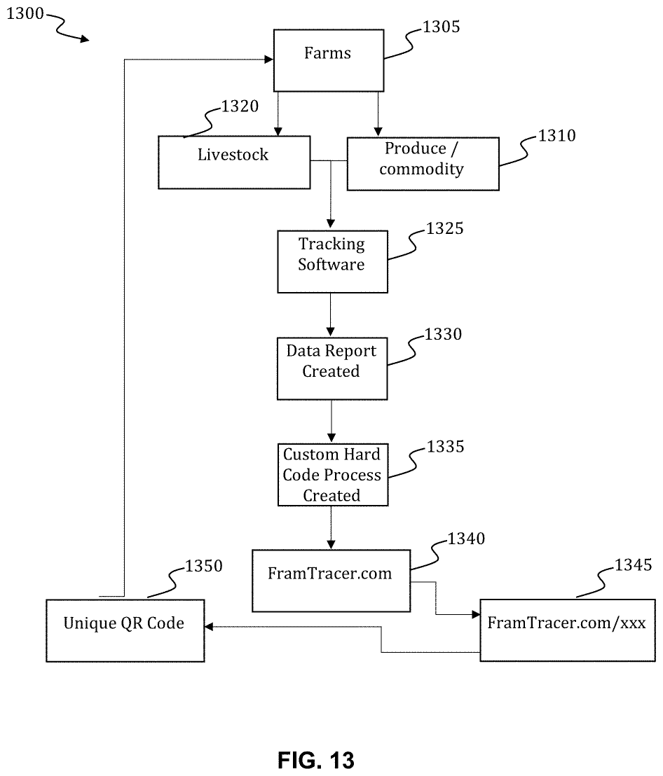

FIG. 13 illustrates a method 1300 in accordance with the disclosed embodiments. The Method begins with a farmer 1305 or other such food producer. The farmer 1305 or food producer may generate produce 1320 or other commodities, and/or may raise livestock 1315. The farmer 1305 can use tracking software 1320 to collect data tracking various aspects of their food production 1320 or livestock 1315. These aspects can include any aspects disclosed herein, including but not limited to, feed, medicine, food supplements, life cycle, production cycle, water use, carbon emissions, etc. It should be appreciated that the farmer 1305 can use a third party data collecting system or tracking software, or such tracking capability may be provided as a software module associated with the current system.

The associated data can be converted into a structured data file, such as a CSV file, JSON file, or the like. In an exemplary embodiment, the stored data, in the CSV file can be used to create a data report 1330, also embodied as a CSV file.

The report 1330 can be provided to the transparency module 430 where a hardcoded custom report 1335 can be created. The hardcoded custom report 1335 can include reorganization of the data for transmission to and/or display on a website , mobile application, or other such system (collectively website 1340). The website 1340, mobile application, etc. can create a custom page 1345 for conveniently and concisely displaying the data collected by the farmer 1305. The system further creates a custom URL 1350 to the page displaying the data which can be provided to the farmer. The farmer can then include the URL 1350 on their product or product packaging, so that an end user can conveniently access the website 1345 displaying the information about the associated food item 460 and/or farmer.

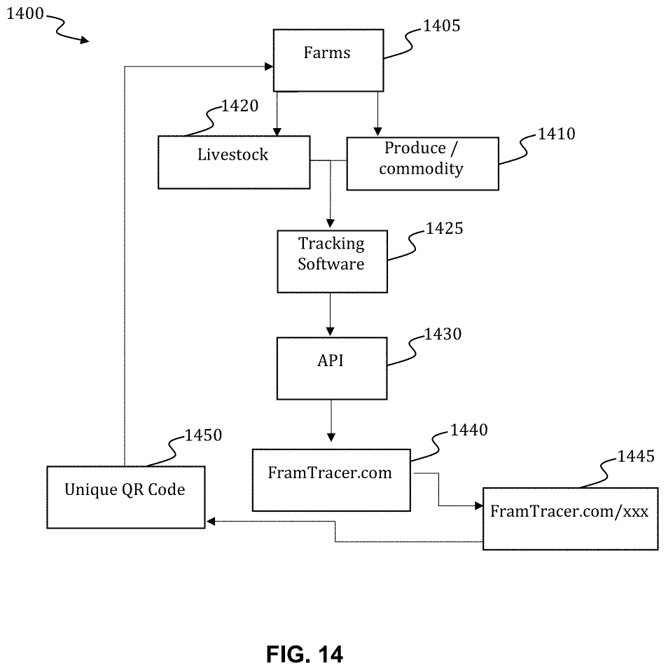

FIG. 14 illustrates a method 1400 in accordance with the disclosed embodiments. The method 1400 begins with a farmer 1405 or other such food producer. The farmer 1405 or food producer may generate produce 1420 or other commodities, and/or may raise livestock 1415. The farmer 1405 can use the tracking software 1425 to collect data tracking various aspects of their food production or livestock. These aspects can include any aspects disclosed herein, including but not limited to, feed, medicine, food supplements, lifecycle, production cycle, water use, carbon emissions, etc. It should be appreciated that the farmer 1405 can use a third party data collecting system or tracking software, or such tracking capability may be provided as a software module associated with the current system.

The associated data can then connect to Application Programming Interface (API) 1430 associated with the disclosed system. The data collected by the tracking system can upload data via the API 1430 to the disclosed system, where the associated data can be formatted and stored.

The API 1430 can create custom report associated with the data. The custom report can include reorganization of the data for transmission to and/or display on a website 1440, mobile application, or other such system (collectively website 1440). The website 1440, mobile application, etc. can create a custom page 1445 for conveniently and concisely displaying the data collected by the farmer 1405. The system further creates a custom URL 1450 to the page displaying the data which can be provided to the farmer 1405. The farmer 1405 can then include the URL 1450 on their product or product packaging, so that an end user can conveniently access the website 1445 displaying the information about the associated food item 460 and/or farmer.

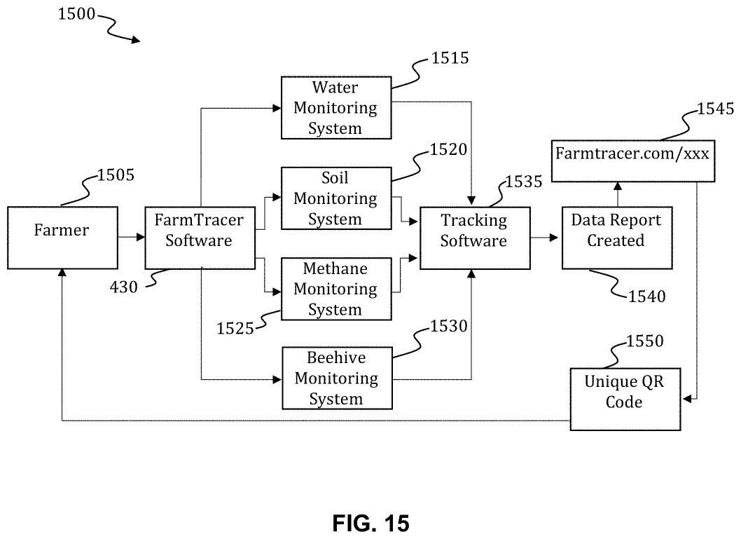

FIG. 15 illustrates another embodiment of a method 1500 associated with the disclosed systems. The method 1500 begins with a farmer 1505 or other such food producer. The farmer 1505 or food producer may generate produce or other commodities, and/or may raise livestock. The disclosed system can provide an interface that the farmer 1505 or food producer can use to collect data. For example, the system 430 can be connected to a water monitoring system 1515, a soil monitoring system 1520, a methane monitoring system 1525, a beehive monitoring system 1530, or other such system. These tracking systems can include sensors configured with data transmission hardware that allows the sensors to report data to the farmer interface.

The system can further include tracking software 1535 that can be operably connected to the various monitoring systems. The tracking software 1535 can create a tracking report 1540 for the various data points supplied by the tracking systems. The tracking software 1535 can then provide data to the transparency module 430 where tracking data can be modified, tabulated, and stored for display.

The tracking report 1535 can include reorganization of the data for transmission to and/or display on a website 1545, mobile application, or other such system (collectively the website 1545). The website 1545, mobile application, etc. can create a custom page for conveniently and concisely displaying the data collected by the farmer 1505. The system further creates a custom URL 1550 to the page displaying the data which can be provided to the farmer 1505. The farmer 1505 can then include the URL 1550 on their product or product packaging, so that an end user can conveniently access the website 1545 displaying the information about the associated food item 460 and/or farmer.

Based on the foregoing, it can be appreciated that a number of embodiments, preferred and alternative, are disclosed herein. For example, in an embodiment, a computer implemented method comprises receiving data associated with a food item, associating a unique identifier with the food item, providing the unique identifier associated with the food item at a point of sale of the food item, and displaying configured data associated the food item, accessible according to the unique identifier provided with the food item.

In an embodiment, the unique identifier comprises at least one of a QR code and a bar code. In an embodiment, the method further comprises generating a web page populated with the configured data associated the food item wherein the unique identifier comprises a link to the web page.

In an embodiment, the data associated with the food item comprises animal data, the animal data further comprising at least one of: animal type, animal age at slaughter, animal genealogy, gross carbon emissions of animal, net carbon emissions of animal, animal diet, animal location, or a combination thereof.

In an embodiment, the data associated with the food item comprises orchard data, the orchard data further comprising at least one of: plant type, plant variety, plant age, pollination time, gross carbon emissions of plant, net carbon emissions of plant, plant location, or a combination thereof.

In an embodiment, the data associated with the food item comprises crop data, the crop data further comprising at least one of: crop type, crop variety, crop row, crop age at harvest, water volume applied to crop, gross carbon emissions of crop, net carbon emissions of crop, location of crop, or a combination thereof.

In an embodiment, the data associated with the food item comprises nut data, the nut data further comprising at least one of: nut type, nut variety, nut tree age at harvest, water volume applied to nut tree, gross carbon emissions of nut tree, net carbon emissions of nut tree, location of nut tree, or a combination thereof.

In an embodiment, receiving data associated with a food item further comprises importing the data associated with the food item.

In an embodiment, the method further comprises calculating a net carbon change associated with the food item according to carbon data associated with the food item wherein the net carbon change associated with the food item comprises total carbon emissions associated with production of the food item less total carbon sequestration associated with the product of the food item.

In an embodiment, the food item comprises a discreet food item for consumer purchase.

In an embodiment, a system for food transparency comprises a computer system, the computer system comprising: at least one processor; and a computer-usable medium embodying computer program code, the computer-usable medium capable of communicating with the at least one processor, the computer program code comprising instructions executable by the at least one processor and configured for: receiving data associated with a food item, generating a unique identifier for the food item, rendering the unique identifier associated with the food item for association with the food item at a point of sale for the food item, and serving configured data associated the food item, accessible using the unique identifier associated with the food item. In an embodiment, the unique identifier comprises at least one of a QR code and a bar code.

In an embodiment, the computer program code comprising instructions executable by the at least one processor is further configured for populating a web page with the configured data associated the food item, wherein the unique identifier comprises a link to the web page.

In an embodiment, the system further comprises a data collection computer system, the data collection computer system comprising: at least one processor; and a computer-usable medium embodying computer program code, the computer-usable medium capable of communicating with the at least one processor, the computer program code comprising instructions executable by the at least one processor and configured for: collecting data associated with the food item and exporting the data associated with the food item.

In an embodiment, the system further comprises at least one of a water monitoring system configured to monitor water usage associated with the food item, a soil monitoring system configured to monitor soil composition associated with the food item, a methane monitoring system configured to monitor methane output associated with the food item, a beehive monitoring system configured to monitor bees associated with the food item, or a combination thereof.

In an embodiment, the computer program code comprising instructions executable by the at least one processor is further configured for generating the configured data associated the food item wherein the food item comprises a discreet food item for consumer purchase.

In an embodiment, the computer program code comprising instructions executable by the at least one processor is further configured for providing feedback data associated with a food producer associated with the food item.

In an embodiment, the computer program code comprising instructions executable by the at least one processor is further configured for calculating a net carbon change associated with the food item according to carbon data associated with the food item. In an embodiment, the net carbon change associated with the food item comprises total carbon emissions associated with production of the food item less total carbon sequestration associated with the product of the food item.

In another embodiment, a system for food transparency comprises a tracking computer system, the tracking computer system comprising: at least one processor; and a computer-usable medium embodying computer program code, the computer-usable medium capable of communicating with the at least one processor, the computer program code comprising instructions executable by the at least one processor and configured for: receiving data associated with a food item, generating a unique identifier for the food item, rendering the unique identifier associated with the food item for association with the food item at a point of sale for the food item, serving configured data associated the food item, accessible using the unique identifier associated with the food item, populating a web page with the configured data associated the food item, wherein the unique identifier comprises a link to the web page, and a data collection computer system, the data collection computer system comprising: at least one processor; and a computer-usable medium embodying computer program code, the computer-usable medium capable of communicating with the at least one processor, the computer program code comprising instructions executable by the at least one processor and configured for: collecting data associated with the food item and exporting the data associated with the food item.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A computer implemented method comprising:
receiving data associated with a food item;
associating a unique identifier with the food item;
providing the unique identifier associated with the food item at a point of sale of the food item; and
displaying configured data associated the food item, accessible according to the unique identifier provided with the food item.

2. The computer implemented method of claim 1 wherein the unique identifier comprises at least one of:
a QR code; or
a bar code.

3. The computer implemented method of claim 2 further comprising:
generating a web page populated with the configured data associated the food item wherein the unique identifier comprises a link to the web page.

4. The computer implemented method of claim 1 wherein the data associated with the food item comprises animal data, the animal data further comprising at least one of:
animal type;
animal age at slaughter;
animal genealogy;
gross carbon emissions of animal;
net carbon emissions of animal;
animal diet;
animal location; or
a combination thereof.

5. The computer implemented method of claim 1 wherein the data associated with the food item comprises orchard data, the orchard data further comprising at least one of:
plant type;
plant variety;
plant age;
pollination time;
gross carbon emissions of plant;
net carbon emissions of plant;
plant location; or
a combination thereof.

6. The computer implemented method of claim 1 wherein the data associated with the food item comprises crop data, the crop data further comprising at least one of:
crop type;
crop variety;
crop row;
crop age at harvest;
water volume applied to crop;
gross carbon emissions of crop;
net carbon emissions of crop;
location of crop; or
a combination thereof.

7. The computer implemented method of claim 1 wherein the data associated with the food item comprises nut data, the nut data further comprising at least one of:
nut type;
nut variety;
nut tree age at harvest;
water volume applied to nut tree;
gross carbon emissions of nut tree;
net carbon emissions of nut tree;
location of nut tree; or
a combination thereof.

8. The computer implemented method of claim 1 wherein receiving data associated with a food item further comprises:
importing the data associated with the food item.

9. The computer implemented method of claim 8 further comprising:
calculating a net carbon change associated with the food item according to carbon data associated with the food item wherein the net carbon change associated with the food item comprises total carbon emissions associated with production of the food item less total carbon sequestration associated with the product of the food item.

10. The computer implemented method of claim 1 wherein the food item comprises a discreet food item for consumer purchase.

11. A system for food transparency comprising:
a computer system, the computer system comprising:
at least one processor; and
a computer-usable medium embodying computer program code, the computer-usable medium capable of communicating with the at least one processor, the computer program code comprising instructions executable by the at least one processor and configured for:
receiving data associated with a food item;
generating a unique identifier for the food item;
rendering the unique identifier associated with the food item for association with the food item at a point of sale for the food item; and
serving configured data associated the food item, accessible using the unique identifier associated with the food item.

12. The system for food transparency of claim 11 wherein the unique identifier comprises at least one of:
a QR code; or
a bar code.

13. The system for food transparency of claim 11 wherein the computer program code comprising instructions executable by the at least one processor is further configured for:
populating a web page with the configured data associated the food item, wherein the unique identifier comprises a link to the web page.

14. The system for food transparency of claim 11 further comprising:
a data collection computer system, the data collection computer system comprising:
at least one processor; and
a computer-usable medium embodying computer program code, the computer-usable medium capable of communicating with the at least one processor, the computer program code comprising instructions executable by the at least one processor and configured for:
collecting data associated with the food item; and
exporting the data associated with the food item.

15. The system for food transparency of claim 14 further comprising at least one of:
a water monitoring system configured to monitor water usage associated with the food item;
a soil monitoring system configured to monitor soil composition associated with the food item;
a methane monitoring system configured to monitor methane output associated with the food item;
a beehive monitoring system configured to monitor bees associated with the food item; or
a combination thereof.

16. The system for food transparency of claim 11 wherein the computer program code comprising instructions executable by the at least one processor is further configured for:
generating the configured data associated the food item wherein the food item comprises a discreet food item for consumer purchase.

17. The system for food transparency of claim 11 wherein the computer program code comprising instructions executable by the at least one processor is further configured for:
providing feedback data associated with a food producer associated with the food item.

18. The system for food transparency of claim 11 wherein the computer program code comprising instructions executable by the at least one processor is further configured for:
calculating a net carbon change associated with the food item according to carbon data associated with the food item.

19. The system for food transparency of claim 18 wherein the net carbon change associated with the food item comprises:
total carbon emissions associated with production of the food item less total carbon sequestration associated with the product of the food item.

20. A system for food transparency comprising:
a tracking computer system, the tracking computer system comprising:
at least one processor; and
a computer-usable medium embodying computer program code, the computer-usable medium capable of communicating with the at least one processor, the computer program code comprising instructions executable by the at least one processor and configured for:
receiving data associated with a food item;
generating a unique identifier for the food item;
rendering the unique identifier associated with the food item for association with the food item at a point of sale for the food item;
serving configured data associated the food item, accessible using the unique identifier associated with the food item; and
populating a web page with the configured data associated the food item, wherein the unique identifier comprises a link to the web page; and
a data collection computer system, the data collection computer system comprising:
at least one processor; and
a computer-usable medium embodying computer program code, the computer-usable medium capable of communicating with the at least one processor, the computer program code comprising instructions executable by the at least one processor and configured for:
collecting data associated with the food item; and
exporting the data associated with the food item.
